(19) United States
(12) Patent Application Publication
(10) Pub. No.: US 2005/0202983 A1
(43) Pub. Date: Sep. 15, 2005

(54) Prevention of loss of tight cell junctions using carbohydrate-containing compositions

(76) Inventors: Erning Xia, Penfield, NY (US); Joseph C. Salamone, Fairport, NY (US); David J. McCanna, Pittsford, NY (US)

Correspondence Address: Bausch & Lomb Incorporated, One Bausch & Lomb Place, Rochester, NY, 14604-2701, US

(21) Appl. No.: 10/799,521

(22) Filed: Mar. 12, 2004

(51) Int. Cl. G02B 1/12

(52) U.S. Cl. 510/119

(57) ABSTRACT

Compositions are described which are useful in preventing the loss of tight epithelial cell junctions upon topical application. Such compositions include one or more carbohydrates in an amount effective to prevent the loss of tight cell junctions and hence improve the management of tissue health.

### FIELD OF THE INVENTION

The present invention is directed toward compositions including one or more carbohydrates useful in the manufacture of gentle suspensions, gels, ointments, solutions, long lasting wetting drops, ophthalmic eye drops and the like. More particularly, the present invention is directed toward the use of one or more compositions that include one or more carbohydrates to prevent the loss of tight epithelial cell junctions thereby increasing ocular comfort.

### BACKGROUND OF THE INVENTION

Contact lenses in wide use today fall into two general categories, hard and soft. The hard or rigid corneal type lenses are formed from materials prepared by the polymerization of acrylic esters, such as poly(methyl methacrylate) (PMMA). The gel, hydrogel or soft type lenses are made by polymerizing such monomers as 2-hydroxyethyl methacrylate (HEMA) or, in the case of extended wear lenses, by polymerizing silicon-containing monomers or macromonomers. Both the hard and soft types of contact lenses are exposed to a broad spectrum of microbes during normal wear and become soiled relatively quickly. Contact lenses whether hard or soft therefore require routine cleaning and disinfecting. Failure to routinely clean and disinfect contact lenses properly can lead to a variety of problems ranging from mere discomfort when being worn to serious ocular infections. Lens care solutions may be harsh on delicate ocular tissues resulting in the loss of tight cell junctions and discomfort. The loss of tight cell junctions may provide a route for ocular infections such as those caused by virulent microbes. One such virulent microbe is Pseudomonas aeruginosa, which can lead to loss of infected eye(s) if left untreated or if allowed to reach an advanced stage before initiating treatment.

U.S. Pat. No. 5,621,094 discloses a method of preserving delicate biological substances or organic compounds in a dry state, at elevated temperatures, and/or under irradiation through the use of a sugar or a sugar derivative.

U.S. patent application Ser. No. 10/724,797 discloses a lens care solution that includes one or more hydroxyalkylamines, one or more polyols, one or more polymer surfactants, one or more disinfecting agents and optionally one or more polysaccharides.

U.S. patent application Ser. No. 10/724,680 discloses the use of cationic polysaccharides to enhance the antimicrobial performance of antimicrobial agents used for disinfection and preservation.

U.S. patent application Ser. No. 10/725,159 discloses a preservative including the use of saccharides in combination with cationic polysaccharides.

U.S. patent application Ser. No. 10/725,049 discloses a preservative including the use of cationic polysaccharides.

Despite the availability of various commercially available contact lens care systems, there continues to be a need for improved systems for improved ocular health management. Such improved systems include systems that are simple to use, are effective against a broad spectrum of microbes, are non-toxic and do not cause ocular irritation as the result of the loss of tight junctions between epithelial cells.

### SUMMARY OF THE INVENTION

The present invention relates to compositions useful in the manufacture of gentle, multipurpose, suspensions, gels, ointments, solutions, lens care solutions, long lasting rewetting drops, ophthalmic eye drops and the like useful for topical application. Such compositions may be useful for nasal sprays, for ear drops, for eye drops, for cleaning, soaking, rinsing, wetting disinfecting and/or conditioning all types of medical devices such as contact lenses, including rigid permeable contact lenses, and for like uses. It has been found that compositions including an effective amount of one or more carbohydrates prevent the loss of tight cell junctions. Loss of tight cell junctions is evidence of tissue damage and can allow for the penetration of irritating chemicals and serve as a route for microbial infections. “Tight cell junctions” as used in the context of the present invention are defined as intact junctions that seal adjacent epithelial cells in a band just beneath their apical surface. The “loss of tight cell junctions” as used in the context of the present invention is defined as a break in the junctions that seal adjacent epithelial cells in a band just beneath their apical surface.

The subject carbohydrate-containing compositions that prevent the loss of tight cell junctions are useful in the manufacture of topical products that are non-toxic, simple to use and reduce or eliminate tissue irritation. For example, in the case of ophthalmic products of the present invention, the loss of tight cellular junctions between corneal epithelial cells and hence ocular irritation is prevented.

Accordingly, it is an object of the present invention to provide compositions useful in the manufacture of ophthalmic products that prevent tissue irritation.

Another object of the present invention is to provide a method for using compositions to condition medical devices.

Another object of the present invention is to provide compositions that prevent the loss of tight epithelial cell junctions when contact lenses are conditioned with lens care solutions containing the same.

Another object of the present invention is to provide a method for using compositions to condition contact lenses.

Another object of the present invention is to provide compositions useful in ophthalmic systems for preserving tight corneal epithelium cell junctions.

Another object of the present invention is to provide a method of making gentle compositions useful in ophthalmic systems.

Still another object of the present invention is to provide a method of using gentle compositions in multipurpose solutions.

These and other objectives and advantages of the present invention, some of which are specifically described and others that are not, will become apparent from the detailed description and claims that follow.

### BRIEF DESCRIPTION OF THE DRAWINGS

FIG. 1 is a scanning electron micrograph of Madin-Darby Canine Kidney (MDCK) cell monolayers following exposure to Minimum Essential Medium (MEM).

FIG. 2 is a scanning electron micrograph of MDCK cell monolayers following exposure to Hank's Balanced Salt Solution (HBSS).

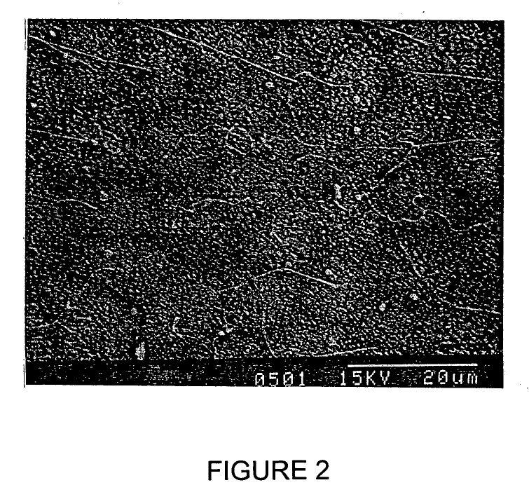

FIG. 3 is a scanning electron micrograph of MDCK cell monolayers following exposure to Sample Test Solution 6.

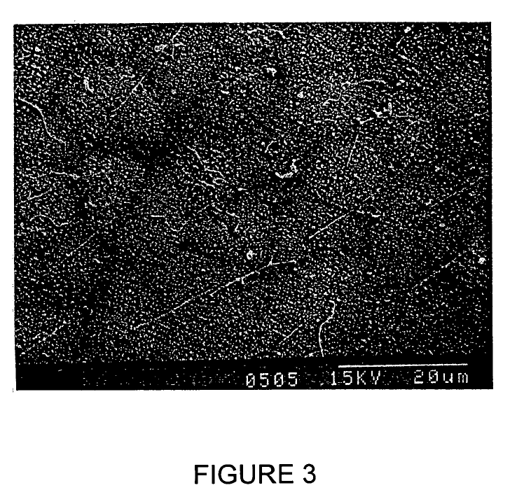

FIG. 4 is a scanning electron micrograph of MDCK cell monolayers following exposure to Sample Test Solution 6.

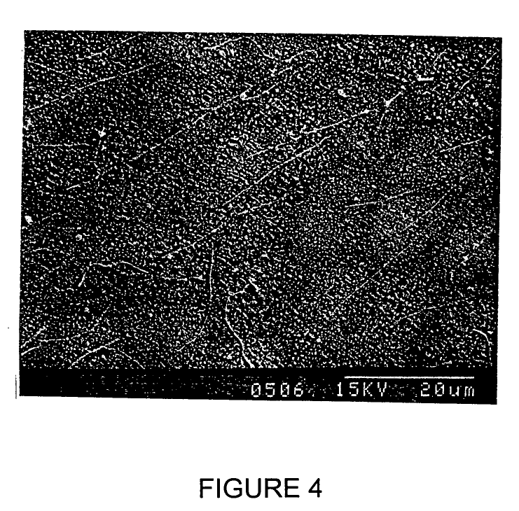

FIG. 5 is a scanning electron micrograph of MDCK cell monolayers following exposure to HBSS followed by exposure to Optifree Express™ (Alcon Laboratories, Fort Worth, Tex.).

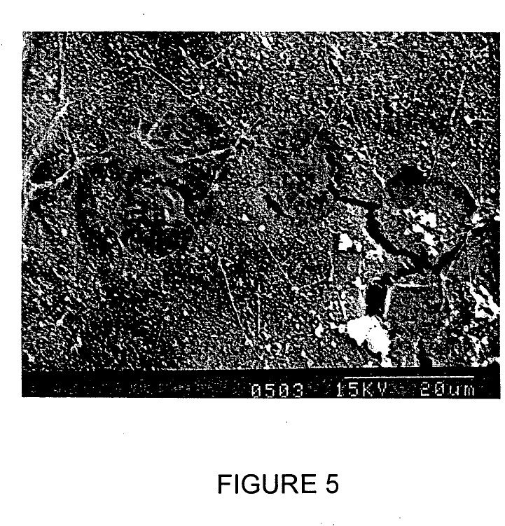

FIG. 6 is a scanning electron micrograph of MDCK cell monolayers following exposure to MEM followed by exposure to Optifree Express™.

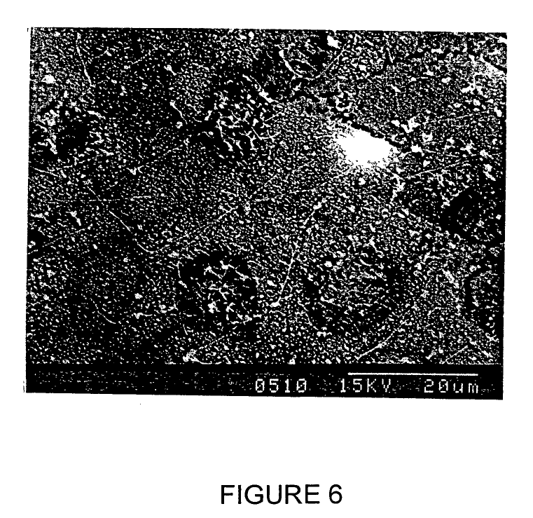

FIG. 7 is a scanning electron micrograph of MDCK cell monolayers following exposure to HBSS followed by exposure to Optifree Express™.

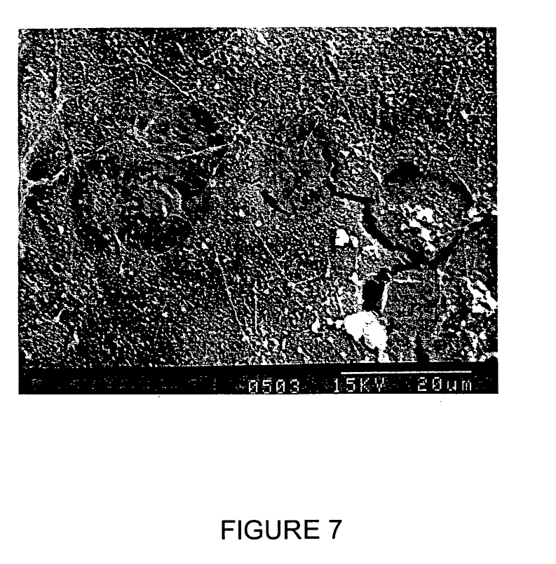

FIG. 8 is a scanning electron micrograph of MDCK cell monolayers following exposure to Sample Test Solution 6 followed by exposure to Optifree Express™.

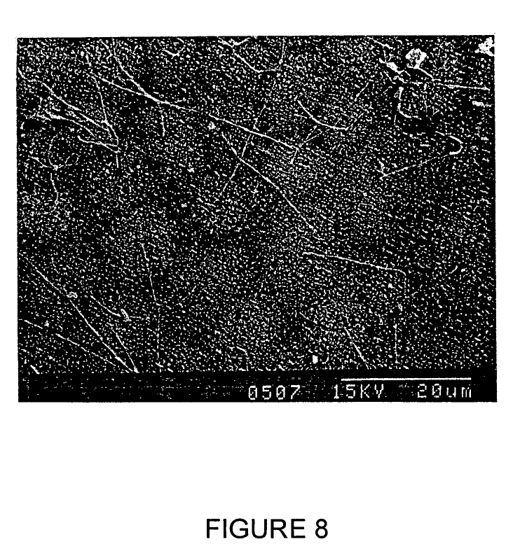

FIG. 9 is a scanning electron micrograph of MDCK cell monolayers following exposure to Sample Test Solution 6 followed by exposure to Optifree Express™.

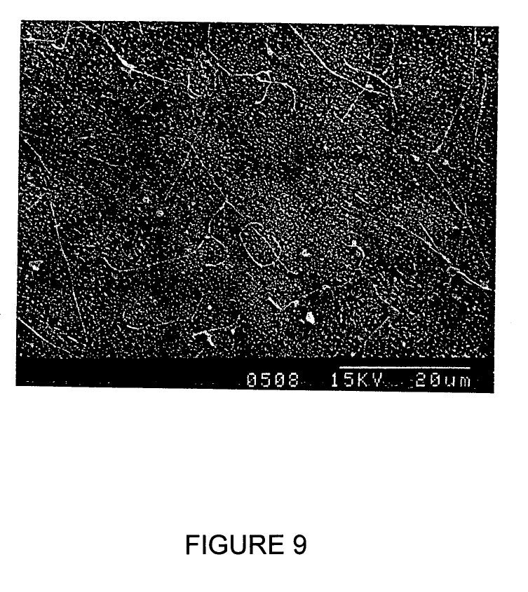

### DETAILED DESCRIPTION OF THE INVENTION

Compositions of the present invention are useful in a variety of forms such as for example, but not limited to solutions, suspensions, gels, ointments, and the like, but for purposes of simplicity will be referred to hereinafter as simply “solutions”. The subject compositions are useful for a variety of topical applications such as nasal sprays, ear drops, eye drops and the like, as well as for contact lens care. Compositions of the present invention are as useful with conventional hard and soft lenses, as with rigid and soft gas permeable lenses. Compositions of the present invention are also suitable for use with hydrogel, non-hydrogel, silicone and fluorine-containing lenses. The term “soft contact lens” as used herein generally refers to those contact lenses that readily flex under small amounts of force. Typically, soft contact lenses are formulated from polymers having a certain proportion of repeat units derived from monomers such as 2-hydroxyethyl methacrylate and/or other hydrophilic monomers, typically crosslinked with a crosslinking agent. However, newer soft lenses, especially for extended wear, are being made from high-Dk silicone-containing materials.

Compositions of the present invention comprise one or more carbohydrates. The carbohydrate-containing compositions of the present invention are useful in the production of multipurpose, gentle solutions. Such gentle solutions may be used as contact lens care solutions employed in disinfecting, cleaning, soaking, rinsing and/or wetting contact lenses. Compositions of the present invention are in solution in sufficient concentration to prevent the loss of tight cell junctions.

Compositions of the present invention in solution are physiologically compatible or “ophthalmically safe” for use with contact lenses. Ophthalmically safe as used herein means that a contact lens treated with or in the subject solution is generally suitable and safe for direct placement on the eye without rinsing. The subject solutions are safe and comfortable for daily contact with the eye via a contact lens that has been wetted with the solution. An ophthalmically safe solution has a tonicity and pH that is compatible with the eye and comprises materials, and amounts thereof, that are non-cytotoxic according to ISO (International Standards Organization) standards and U.S. FDA (Food and Drug Administration) regulations. Solutions of the present invention are sterile in that the absence of microbial contaminants in the solution product prior to release may be statistically demonstrated to the degree necessary for such products.

As noted previously, carbohydrate-containing compositions of the present invention have surprisingly been found to prevent the loss of tight junctions between epithelial cells in vitro. Loss of tight junctions and defects in the integrity of the epithelium can be detected by using a sodium fluorescein solution and detecting the sodium fluorescein permeability using a fluorometer. Carbohydrate-containing compositions of the present invention stabilize lipids and proteins of epithelium cell membranes and thus preserve tight junctions between corneal epithelial cells and cause less tissue irritation. The subject compositions containing one or more carbohydrates such as monosaccharides, disaccharides, oligosaccharides and polysaccharides provide an unique method for managing ocular health.

As noted above, compositions of the present invention include one or more carbohydrates. One or more carbohydrates are present in the subject compositions in a total amount of from approximately 0.01 to approximately 10.0 percent by weight based on the total weight of the composition, but more preferably from about 0.05 to about 5.0 percent by weight. Suitable carbohydrates for use in compositions of the present invention include for example but are not limited to monosaccharides, disaccharides, oligosaccharides and polysaccharides. Suitable monosaccharides include for example but are not limited to allose, altrose, glucose, mannose, gulose, idose, galactose, talose, ribose, arabinose, xylose and lyxose. Examples of suitable disaccharides are sucrose and trehalose. Suitable oligosaccharides, composed of two to eight units of monosaccharide, and polysaccharides, composed of more than eight units of monosaccharide, include for example but are not limited to agar, agarose, guar gum, hydroxypropylguar, hydroxypropylmethylguar, hydroxyethylguar, carboxymethylguar, gum arabic, dextran, locust bean, alginates, asafetida, gum benzoin, carragreenans, carob, colophone, galbanum, gum damar, gum cassia, hydroxyethylcelluose, hydroxypropylcellulose, hydroxypropylmethylcellulose, methylcellulose, carboxymethylcellulose, gum chicle, gum elemi, gum gambodge, gum rosin, gum sandarac, gum tara, gum terpentine, gum tragacanth, xanthan gum, gum yucca, pectin, gellen gum, hyaluronic acid, chondroitin sulfate, gum ghatti, gum guaiac, gum guaiac, gum guarana, gum guttae, gum karaya, gum konjac, gum mastix, gum myrrh and gum olibanum.

In addition to one or more carbohydrates, compositions of the present invention may optionally include one or more buffers, such as aminoalcohol buffers, such as for example but not limited to ethanolamine buffers present in a total amount of from approximately 0.02 to approximately 3.0 percent by weight based on the total weight of the composition. Suitable aminoalcohol buffers include for example but are not limited to monoethanolamine (MEA), diethanolamine (DEA), triethanolamine (TEA), 2-amino-2-methyl-1,3-propanediol (AMPD), 2-dimethylamino-2-methyl-1-propanediol (DMAMP), 2-amino-2-ethylpropanol (AEP), 2-amino-1-butanol (AB) and 2-amino-2-methyl-1-propanol (AMP), but preferably MEA, DEA or TEA.

Compositions of the present invention may likewise optionally include one or more surfactants having known advantages in terms of cleaning efficacy and comfort when used in contact lens care solutions. Surfactants may be present in the subject compositions in a total amount of from approximately 0.001 to approximately 5.0 percent by weight based on the total weight of the composition, but more preferably from about 0.1 to about 0.5 percent by weight. Suitable surfactants include for example but are not limited to polyethers based upon poly(ethylene oxide)-poly(propylene oxide)-poly(ethylene oxide), i.e., (PEO-PPO-PEO), or poly(propylene oxide)-poly(ethylene oxide)-poly(propylene oxide), i.e., (PPO-PEO-PPO),or a combination thereof. PEO-PPO-PEO and PPO-PEO-PPO are commercially available under the trade names Pluronics™, R-Pluronics™, Tetronics™ and R-Tetronics™ (BASF Wyandotte Corp., Wyandotte, Mich.) and are further described in U.S. Pat. No. 4,820,352 incorporated herein in its entirety by reference. Suitable surfactants for use in the present composition should be soluble in the lens care solution, not become turbid, and should be non-irritating to eye tissues.

Optionally, it may be desirable to include one or more water-soluble viscosity agents in the subject compositions. Because of the demulcent effect of viscosity agents, the same have a tendency to enhance the lens wearer's comfort by means of a film on the lens surface cushioning impact against the eye. Suitable viscosity agents include for example but are not limited to cellulose polymers like hydroxyethyl or hydroxypropyl cellulose, carboxymethyl cellulose, povidone, poly(vinyl alcohol) and the like. Viscosity agents may be employed in amounts ranging from about 0.01 to about 4.0 weight percent or less.

Compositions of the present invention when in solution include one or more buffers, or a buffering system in addition to the aminoalcohol buffer, if any, to adjust the final pH of the solution. Suitable buffers include for example but are not limited to phosphate buffers, borate buffers, tris(hydroxymethyl)aminomethane (Tris) buffers, bis(2-hydroxyethyl)imino-tris(hydroxymethyl)methane (bis-Tris) buffers, sodium bicarbonate buffers, citrate buffers and combinations thereof. A suitable buffering system for example may include at least one phosphate buffer and at least one borate buffer, which buffering system has a buffering capacity of 0.01 to 0.5 mM, preferably 0.03 to 0.45, of 0.01 N of HCl and 0.01 to 0.3, preferably 0.025 to 0.25, of 0.01 N of NaOH to change the pH one unit. Buffering capacity is measured by a solution of the buffers only. The pH of lens care solutions of the present invention is preferably maintained within the range of 5.0 to 8.0, more preferably about 6.0 to 8.0, most preferably about 6.5 to 7.8.

Compositions of the present invention may likewise optionally include one or more tonicity agents to approximate the osmotic pressure of normal lachrymal fluids, which is equivalent to a 0.9 percent solution of sodium chloride or 2.5 percent glycerin solution. Examples of suitable tonicity agents include but are not limited to sodium and potassium chloride, dextrose, mannose, glycerin, calcium and magnesium chloride. These agents are typically used individually in amounts ranging from about 0.01 to 2.5 percent weight per volume and preferably, from about 0.2 to about 1.5 percent weight per volume. Preferably, the tonicity agent is employed in an amount to provide a final osmotic value of 200 to 450 mOsm/kg and more preferably between about 220 to about 350 mOsm/kg, and most preferably between about 220 to about 320 mOsm/kg.

Compositions of the present invention may also include one or more sequestering agents to bind metal ions, which in the case of ophthalmic solutions, might otherwise react with protein deposits and collect on contact lenses. Suitable sequestering agents include for example but are not limited to ethylenediaminetetraacetic acid (EDTA) and its salts. Sequestering agents are preferably used in amounts ranging from about 0.01 to about 0.2 weight percent.

The compositions of the present invention are described in still greater detail in the examples that follow.

### EXAMPLE 1

### Preparation of Test Solutions

Sample solutions for testing were prepared in accordance with the formulations set forth below in Table 1.

TABLE 1
Test Solutions

| Ingredients | Solutions | | | | | |
|---|---|---|---|---|---|---|
| W/W Percent | 1 | 2 | 3 | 4 | 5 | 6 |
| Sodium Chloride | 0.65 | 0.81 | 0.40 | 0.90 | 0.67 | 0.94 |
| Trehalose | 3.00 | 1.50 | 0 | 0 | 3.00 | 0 |
| Galactose | 0 | 0 | 3.00 | 0 | 0 | 0 |
| Gellen gum | 0 | 0 | 0 | 0.50 | 0 | 0 |
| Locust Bean Gum | 0 | 0 | 0 | 0 | 0 | 0.50 |
| Purified Water | Quantity required to bring each solution 1-6 to 100 gm | | | | | |
| Osmolality (mOsm/Kg) | 294 | 300 | 302 | 300 | 295 | 297 |

### EXAMPLE 2

### In-Vitro Sodium Fluorescein Permeability Assay Preparation

Five tenths of 1 ml of a cell suspension containing 2×10⁵ per ml cells were seeded in Millicell™ HA 13 mm inserts (Millipore, Bedford, Mass.). The inserts were transferred into 24-well plates containing 0.5 ml of Minimum Essential Medium (MEM) per well. The plates were then incubated at 37° C. with five percent CO₂ for six days. Fresh media was added to the wells and the inserts on days two through six. On day six, the inserts were used for the permeability assay.

### EXAMPLE 3

### One Hour Incubation with Test Solution with Challenge of Optifree Express™ (Twenty Minute Exposure)

Each insert prepared in accordance with Example 2 above was gently rinsed three times with 1 ml of Hank's Balanced Salt Solution (HBSS) without phenol red, using a 10 ml syringe without a needle. Five tenths of 1 ml of Test Solution 6 was added to separate inserts that had been placed in a fresh 24-well plate. Triplicate inserts were used for each test solution. The inserts were incubated in a 100 percent humidified chamber at 37° C. for one hour. Each series of triplicate samples were handled sequentially to allow exact timing of the treatment and subsequent steps. After incubation, each insert was individually rinsed five times with 1 ml HBSS using a 10 ml syringe without a needle.

Five tenths of 1 ml of Optifree Express™ (Alcon Laboratories, Fort Worth, Tex.) was added to separate inserts, which had been placed in a fresh 24-well plate. Triplicate inserts were used for each test solution. The inserts were incubated in a 100 percent humidified chamber at 37° C. for 20 minutes. After incubation, each insert was individually rinsed five times with 1 ml HBSS using a 10 ml syringe without a needle.

Five tenths of 1 ml of sodium fluorescein (3 mg/100 ml in HBSS) was added to each insert. The inserts were placed in a 24-well plate with 0.5 ml HBSS in each well and incubated at room temperature for 20 minutes. The inserts were then removed from the wells, and the amount of sodium fluorescein was measured using a fluorometer at 540 nm excitation and 590 nm emission.

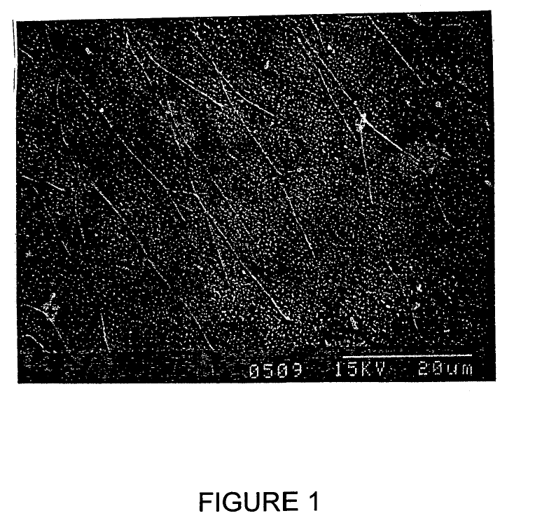

HBSS—HBSS (HH), HBSS—Optifree Express (HO), Test Solution 6—Test Solution 6 (TS6), Test Solution 6—Optifree Express (TS6O), Medium—Medium (MM) and Medium—Optifree Express (MO), were run in the sequence and time as described above. The results are set forth below in Table 2. The results illustrate the protective effects of Test Solution 6 (relatively low fluorescein permeability average) as opposed to the damaging effects of Optifree Express (relatively high fluorescein permeability average) with regard to tight junctions. Pretreatment with Test Solution 6 followed by exposure to Optifree Express caused less permeability than pretreatment with HBSS or MEM. This protective effect is also illustrated in the scanning electron micrographs of FIGS. 1 throught 9 taken of test cultures following their exposure to the above-described treatments as described in more detail in Example 6 below.

TABLE 2
Fluorescein Permeability

| Solutions | Average | Standard Deviation |
|---|---|---|
| HBSS—HBSS | 42.00 | 3.00 |
| HBSS - Optifree Express | 195.00 | 35.00 |
| TS6—TS6 | 18.00 | 7.00 |
| TS6 - Optifree Express | 93.00 | 9.00 |
| Medium—Medium | 32.00 | 6.00 |
| Medium - Optifree Express | 175.00 | 70.00 |

### EXAMPLE 4

### Pretreatment Prior to Thirty Minute Incubation with Test Solution with Challenge of Optifree Express™ (Thirty Minute Exposure)

The same methodology was used as that set forth above in Example 3 except that the pretreatment step consisted of a thirty minute preincubation with Test Solution 6 followed by challenge with Optifree Express™ with a thirty minute exposure and a thirty minute incubation with Na-Fluorescein. The results are set forth below in Table 3. The results illustrate the protective effects of Test Solution 6 (relatively low fluorescein permeability average) as opposed to the damaging effects of Optifree Express (relatively high fluorescein permeability average) with regard to tight junctions. Pretreatment with Test Solution 6 followed by exposure to Optifree Express caused less permeability than pretreatment with HBSS.

TABLE 3
Fluorescein Permeability

| Solutions | Average | Standard Deviation |
|---|---|---|
| Test Solution 3 - Optifree Express | 217.00 | 14.00 |
| Test Solution 4 - Optifree Express | 275.00 | 47.00 |
| Test Solution 5 - Optifree Express | 313.00 | 27.00 |
| TS6 - Optifree Express | 114.00 | 68.00 |
| HBSS - Optifree Express | 348.00 | 105.00 |
| Medium Only | 28.00 | 7.00 |

### EXAMPLE 5

### Prevention Effect of Trehalose on the Loss of Tight Junctions Between Epithelium Cells Using In-Vitro Sodium Fluorescein Permeability Assay of Example 2

The same methodology was used as that set forth above in Example 3 except that the pretreatment step consisted of a thirty minute preincubation with either Test Solution 1 or Test Solution 2 followed by challenge with Optifree Express™ with a thirty minute exposure and a thirty minute incubation with Na-Fluorescein, or the pretreatment step consisted of a thirty minute preincubation with Optifree Express™ followed by challenge with either Test Solution 1 or Test Solution 2 with a thirty minute exposure and a thirty minute incubation with Na-Fluorescein. Results are set forth below in Table 4. Results illustrate that epithelial monolayers pretreated with trehalose, e.g., Test Solution 1 and Test Solution 2, were less permeable to sodium fluorescein than cultures pretreated with Optifree Express followed by exposure to Test Solution 1 and Test Solution 2.

TABLE 4
Prevention Effect of Trehalose on the Loss of Tight Junctions
Between Epithelium Cells

| | Treated with Optifree | | | |
|---|---|---|---|---|
| | Express Followed | | Pretreated with Test | |
| | by Treatment with | | Solutions Followed by | |
| | The Test Solutions | | Treatment with Optifree | |
| | | Standard | Express | |
| Sample | Average | Deviation | Average | Standard Deviation |
| Test Solution 1 | 338.0 | 105.0 | 181.0 | 28.0 |
| Test Solution 2 | 331.0 | 61.0 | 219.0 | 36.0 |

### EXAMPLE 6

### Scanning Electron Microscopy

The Madin-Darby Canine Kidney (MDCK) cell monolayers used in permeability assays were fixed in 2 percent glutaraldehyde in phosphate-buffered saline (PBS) for two hours at room temperature. The inserts were then transferred to PBS and kept at 4° C. until processed for dehydration. After dehydration with graded ethanol, from 50 percent to 100 percent, the inserts were immersed in hexamethyldisilazane for 10 minutes, removed, and then air dried in a fume hood. Samples were sputter-coated with gold and examined with a Hitachi™ S530 scanning electron microscope (Hitachi Corporation, Tokyo, Japan).

Solutions containing one or more compositions of the present invention may be formulated into specific contact lens care products for use as customary in the field of ophthalmology. Such products include but are not limited to wetting solutions, soaking solutions, cleaning and conditioning solutions, disinfecting solutions, packaging solutions, as well as in-eye cleaning and conditioning solutions.

While the invention has been described in conjunction with specific examples thereof, this is illustrative only. Accordingly, many alternatives, modifications, and variations will be apparent to those skilled in the art in the light of the foregoing description and it is, therefore, intended to embrace all such alternatives, modifications, and variations as to fall within the spirit and scope of the appended claims.

1. Compositions comprising:
one or more carbohydrates in an amount effective for preserving tight cell junctions.

2. The compositions of claim 1 wherein said one or more carbohydrates are selected from the group consisting of monosaccharides, disaccharides, oligosaccharides and polysaccharides.

3. The compositions of claim 1 wherein said one or more carbohydrates are selected from the group consisting of agar, agarose, guar gum, hydroxypropylguar, hydroxypropylmethylguar, hydroxyethylguar, carboxymethylguar, gum arabic, dextran, locust bean, alginates, asafetida, gum benzoin, carragreenans, carob, colophone, galbanum, gum damar, gum cassia, hydroxyethylcelluose, hydroxypropylcellulose, hydroxypropylmethylcellulose, methylcellulose, carboxymethylcellulose, gum chicle, gum elemi, gum gambodge, gum rosin, gum sandarac, gum tara, gum terpentine, gum tragacanth, xanthan gum, gum yucca, pectin, gellen gum, hyaluronic acid, chondroitin sulfate, gum ghatti, gum guaiac, gum guaiac, gum guarana, gum guttae, gum karaya, gum konjac, gum mastix, gum myrrh and gum olibanum.

4. A method of producing compositions of claim 1 comprising:
combining one or more carbohydrates in an amount effective for preserving tight cell junctions.

5. The method of claim 4 wherein said one or more carbohydrates are selected from the group consisting of monosaccharides, disaccharides, oligosaccharides and polysaccharides.

6. The method of claim 4 wherein said one or more carbohydrates are selected from the group consisting of agar, agarose, guar gum, hydroxypropylguar, hydroxypropylmethylguar, hydroxyethylguar, carboxymethylguar, gum arabic, dextran, locust bean, alginates, asafetida, gum benzoin, carragreenans, carob, colophone, galbanum, gum damar, gum cassia, hydroxyethylcelluose, hydroxypropylcellulose, hydroxypropylmethylcellulose, methylcellulose, carboxymethylcellulose, gum chicle, gum elemi, gum gambodge, gum rosin, gum sandarac, gum tara, gum terpentine, gum tragacanth, xanthan gum, gum yucca, pectin, gellen gum, hyaluronic acid, chondroitin sulfate, gum ghatti, gum guaiac, gum guaiac, gum guarana, gum guttae, gum karaya, gum konjac, gum mastix, gum myrrh and gum olibanum.

7. A solution, suspension, gel or ointment comprising one or more carbohydrates in an amount effective for preserving tight cell junctions.

8. The solution, suspension, gel or ointment of claim 7 wherein said solution, suspension, gel or ointment includes one or more buffers or buffering systems.

9. The solution, suspension, gel or ointment of claim 7 wherein said solution, suspension, gel or ointment includes one or more tonicity agents.

10. The solution, suspension, gel or ointment of claim 7 wherein said one or more carbohydrates are selected from the group consisting of monosaccharides, disaccharides, oligosaccharides and polysaccharides.

11. The solution, suspension, gel or ointment of claim 7 whrerein said one or more carbohydrates are selected from the group consisting of agar, agarose, guar gum, hydroxypropylguar, hydroxypropylmethylguar, hydroxyethylguar, carboxymethylguar, gum arabic, dextran, locust bean, alginates, asafetida, gum benzoin, carragreenans, carob, colophone, galbanum, gum damar, gum cassia, hydroxyethylcelluose, hydroxypropylcellulose, hydroxypropylmethylcellulose, methylcellulose, carboxymethylcellulose, gum chicle, gum elemi, gum gambodge, gum rosin, gum sandarac, gum tara, gum terpentine, gum tragacanth, xanthan gum, gum yucca, pectin, gellen gum, hyaluronic acid, chondroitin sulfate, gum ghatti, gum guaiac, gum guaiac, gum guarana, gum guttae, gum karaya, gum konjac, gum mastix, gum myrrh and gum olibanum.

12. The solution, suspension, gel or ointment of claim 7 wherein said solution, suspension, gel or ointment includes one or more surfactants.

13. The solution, suspension, gel or ointment of claim 7 wherein said solution, suspension, gel or ointment includes one or more viscosity agents.

14. A method of using the solution, suspension, gel or ointment of claim 7 comprising:
contacting a surface of a contact lens with said solution, suspension, gel or ointment for a period of time prior to placement in an eye.

15. A method of using the solution, suspension, gel or ointment of claim 7 comprising:
contacting a surface of a medical device with said solution, suspension, gel or ointment for a period of time prior to contacting tissue with said medical device.

16. A method of using the solution, suspension, gel or ointment of claim 7 comprising:
contacting tissue with said solution, suspension, gel or ointment.

17. A method of producing the solution, suspension, gel or ointment of claim 7 comprising:
adding an effective amount of one or more carbohydrates to said solution, suspension, gel or ointment.

18. A lens care solution comprising:
one or more carbohydrates in solution in an amount effective to prevent the loss of tight cell junctions.
